(19) United States
(12) Patent Application Publication
(10) Pub. No.: US 2013/0298828 A1
(43) Pub. Date: Nov. 14, 2013

(54) THERMAL SPRAY APPARATUS

(71) Applicants: Murray N. Underhill, King, NC (US); Gary J. Gingras, Granville, MA (US)

(72) Inventors: Murray N. Underhill, King, NC (US); Gary J. Gingras, Granville, MA (US)

(21) Appl. No.: 13/467,331

(22) Filed: May 9, 2012

(51) Int. Cl. B05B 15/12

(52) U.S. Cl. 118/712; 118/300

(57) ABSTRACT

A thermal spray apparatus (100) is provided, including a booth (102) and a spray mechanism (106) in the booth configured to switch between an operating mode (108) and a safe mode (114). An operator (118) in the booth is protected from an emission (120) from the spray mechanism in the safe mode. The thermal spray apparatus includes a safety interlock for the spray mechanism, where the safety interlock switches between an operating condition in which the spray mechanism is configured to operate in either of the operating mode or the safe mode and a safe condition in which the spray mechanism is prevented from operating in the operating mode. The safety interlock switches to the safe condition upon an operator being enabled to enter the booth.

### FIELD OF THE INVENTION

The invention relates to a thermal spray apparatus and more specifically, to a safety device to protect an operator during use of a thermal spray apparatus.

### BACKGROUND OF THE INVENTION

Thermal spray systems are used to provide a coating on high-temperature components, for example gas turbine components. The thermal spray systems typically involve melting a particulate material, spraying the melted material onto a surface of the high-temperature component, wherein the melted material subsequently cools and adheres to the surface to form the coating.

Conventional thermal spray systems include a booth with a spray mechanism mounted in the booth. The spray mechanism may be a plasma spray mechanism or a HVOF (high velocity oxygen fuel) spray mechanism, for example. A high-temperature component, such as a gas turbine component, is positioned on a mount in the booth and is sprayed by the spray mechanism in an operating mode until the coating is formed on the high-temperature component. While in the operating mode, the spray mechanism can emit particles, UV (ultraviolet) rays and sound which can be harmful to an operator who is located in the booth. Thus, the spray mechanism is shut down after spraying a high-temperature component, so that the operator can safely enter the booth to replace the sprayed high-temperature component on the mount with the next high-temperature component to be sprayed. The operator then leaves the booth and powers up the spray mechanism into the operating mode, to spray the next high-temperature component on the mount in the booth. This process is repeated until the operator has sprayed all of the high-temperature components.

### BRIEF DESCRIPTION OF THE DRAWINGS

The invention is explained in the following description in view of the drawings that show:

FIG. 1 is a schematic illustration of a thermal spray apparatus in an operating mode;

FIG. 2 is a schematic illustration of the thermal spray apparatus of FIG. 1 in a safe mode;

FIG. 3 is a block diagram of a controller in the thermal spray apparatus of FIG. 1; and

FIG. 4 is a cross-sectional side view of a shield in the thermal spray apparatus of FIG. 1.

### DETAILED DESCRIPTION OF THE INVENTION

The present inventors have recognized several limitations of the conventional thermal spray systems used to apply a coating to high-temperature components. As discussed above, conventional thermal spray systems require that the spray mechanism is powered down after spraying a high-temperature component, so that the operator can safely enter the booth to replace the high-temperature component, and that the spray mechanism is powered up after the operator safely leaves the booth, to spray the next high-temperature component. The present inventors recognized that this repeated powering down and powering up of the spray mechanism, particularly for a larger number of high-temperature components, could have an adverse effect on the components of the spray mechanism. For example, with a plasma spray mechanism, each instance of powering up the spray mechanism involves initiating an electric arc across the nozzle of the spray mechanism, which adversely affects the condition of the nozzle after large instances of powering up the spray mechanism. Thus, the present inventors have developed an improved spray mechanism which need not be powered down and powered up between the spraying of each high-temperature component, thus reducing wear and tear over time.

Additionally, the present inventors recognized that the above-required powering down and powering up of the conventional spray system for each high-temperature component extends the required time to spray a plurality of high-temperature components, thereby reducing the time efficiency for spraying the high-temperature components. Thus, by developing the improved spray mechanism which need not be powered down and powered up in between each high-temperature component, the present inventors developed an improved spray mechanism that enhances the time efficiency for spraying the high-temperature components.

Additionally, the present inventors recognized that while the conventional thermal spray systems have some safety features, such as powering down the spray mechanism in between the spraying of each high-temperature component, the conventional spray thermal spray systems do not include additional safety features to require that the spray mechanism remains powered down when the operator is in the booth. For example, the present inventors recognized that the spray mechanism of the conventional thermal spray system could be accidentally activated by a second operator outside of the booth while a first operator is in the booth. Thus, the present inventors developed a safety interlock, which prevents the spray mechanism from entering the operating mode while the operator is in the booth.

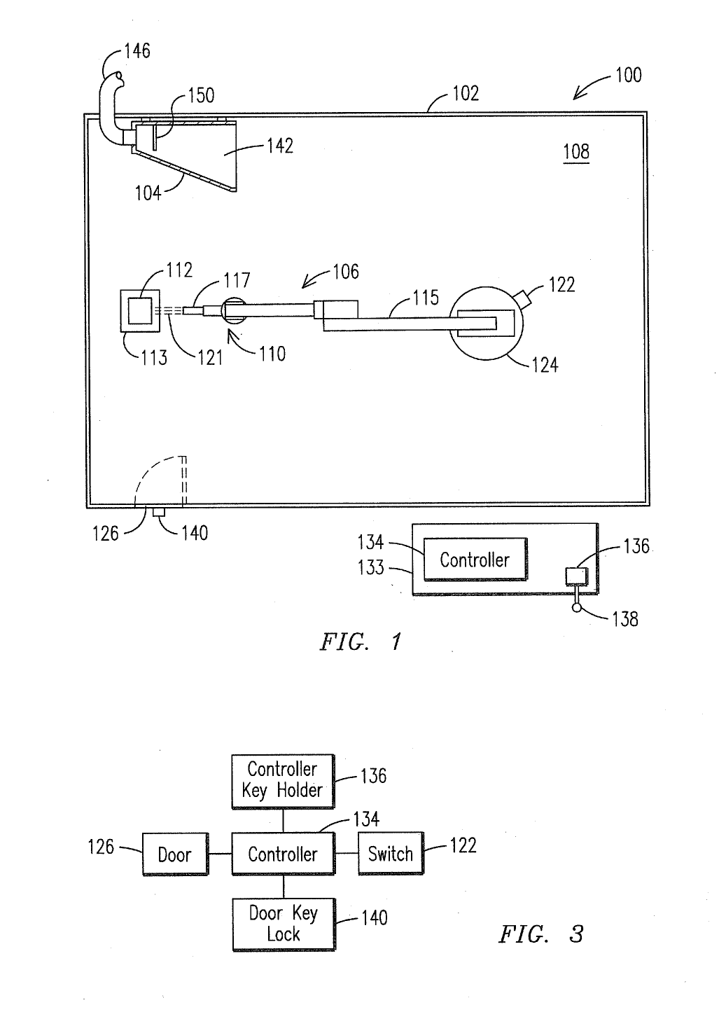

FIG. 1 illustrates a thermal spray apparatus 100 including a booth 102 with a door 126. The thermal spray apparatus 100 also includes a shield 104 that is positioned within the booth 102, such as mounted to an interior wall of the booth 102, for example. The shield 104 may be a box with an inlet 142 or opening at one end and an outlet 148 at an opposite end, where an exhaust 146 is coupled to the outlet 148. The exhaust 146 is configured to direct dust and fumes through the outlet 148 and out of the shield 104, as discussed below.

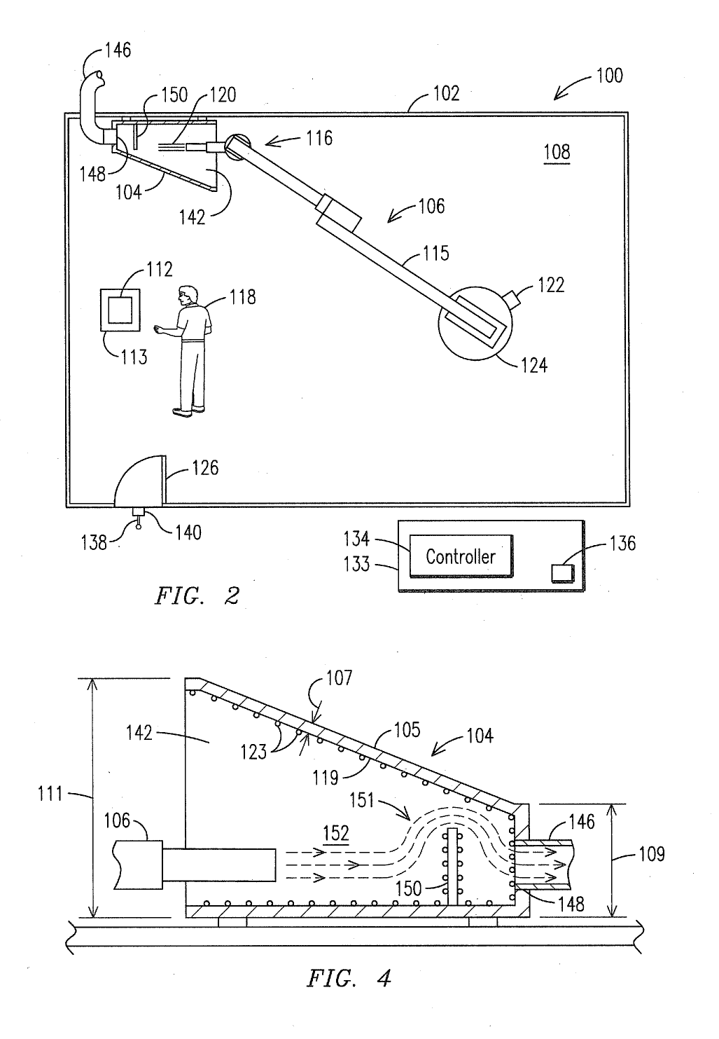

As further illustrated in FIG. 1, the thermal spray apparatus 100 includes a spray mechanism 106 positioned in the booth 102. A base 124 of the spray mechanism 106 is mounted to a floor of the booth 102, to secure the spray mechanism 106 within the booth 102. As further illustrated in FIG. 1, the spray mechanism 106 includes a robot arm 115 and a spray gun 117, where one end of the robot arm 115 is secured to the base 124 and the spray gun 117 is attached to an opposite end of the robot arm 115. A control panel 133 is positioned outside the booth 102 and includes a controller 134 for the spray mechanism 106. The controller 134 can switch the spray mechanism 106 into an operating mode 108 (FIG. 1) in which the controller 134 moves the spray mechanism 106 to a spray position 110 so that the spray gun 117 sprays a component 112 positioned on a mount 113 in the booth 102. After the spray mechanism 106 has completed the spraying of the component 112, the controller 134 switches the spray mechanism 106 into a safe mode 114 (FIG. 2) in which the controller 134 moves the spray mechanism 106 to a parked position 116 behind the shield 104 so that the spray gun 117 is inserted into an inlet 142 of the shield 104, to protect an operator 118 within the booth 102 from an emission 120 from the spray mechanism 106. During the safe mode 114, the controller 134 switches the spray mechanism 106 to an idle mode, in which a reduced supply of fuel and/or electric power is supplied to the spray gun 117, and the flow of particles through the spray gun 117 is stopped, resulting in a reduced emission 120 from the spray mechanism 106 compared to the emission 121 from the spray mechanism 106 during the operating mode 108 (FIG. 1). In an exemplary embodiment, a HVOF spray mechanism may be used, in which an emission of approximately 600 cubic feet of oxygen and 1400 cubic feet of hydrogen gas is used during the operating mode, while a reduced emission of approximately 200 cubic feet of oxygen and 500 cubic feet of hydrogen gas is used during the idle mode, for example. In another exemplary embodiment, a plasma spray mechanism may be used, in which a 600 amp current is used during the operating mode, while a reduced 150 amp current is used during the idle mode, for example. Significantly, the electrical arc in the plasma spray mechanism is maintained in the idle mode so that damage to the electrodes that may occur during initiation of the arc is avoided. These specific emissions from the HVOF spray mechanism and plasma mechanism are merely exemplary and the embodiments of the present are not limited to these specific emissions or these specific types of spray mechanisms. The emission 120 from the spray mechanism 106 may be a particle emission, a radiation emission and/or a sound emission. In an exemplary embodiment, the radiation emission from the spray mechanism 106 may be a UV (ultraviolet) emission. In an exemplary embodiment, the shield 104 is configured to block substantially all of the radiation emission from the spray mechanism 106. Additionally, in an exemplary embodiment, the shield 104 is configured to significantly reduce the sound emission from the spray mechanism 106, to protect the operator 118 within the booth 102. The shield 104 also captures and vents all gas emissions and any particle emission from the spray gun 117.

As further illustrated in FIGS. 1-2, the thermal spray apparatus 100 includes a position sensor such as switch 122 positioned at the base 124 of the spray mechanism 106. The switch 122 is activated upon a movement of the spray mechanism 106 from the parked position 116 behind the shield 104. For example, the switch 122 may be a magnetic switch configured to detect a rotation of the base 124 of the spray mechanism 106, where the movement of the spray mechanism 106 from the parked position 116 causes the rotation of the base 124. Other types of position sensors may be used, such as a limit switch, a counter, a laser, etc. Although a specific example of a magnetic switch positioned at a base of the spray mechanism is discussed herein, the embodiments of the present invention are not limited to a magnetic switch nor to a switch positioned at a base of the spray mechanism, and encompass any sensor capable of detecting the movement of the spray mechanism away from the parked position.

As further illustrated in FIGS. 1-2, a key 138 is positioned in a holder 136 of the control panel 133 outside the booth 102. The key 138 is positioned within the holder 136, in order for an operator 118 to use the controller 134 outside the booth 102 and switch the spray mechanism 106 from the operating mode 108 (FIG. 1) to the safe mode 114 (FIG. 2) and subsequently from the safe mode 114 back to the operating mode 108. If the key 138 is removed from the holder 136, the operator 118 will not be able to use the controller 134 to switch the spray mechanism 106 between the operating mode 108 (FIG. 1) and the safe mode 114 (FIG. 2). Thus, removing the key 138 from the key holder 136 does not shut down the spray mechanism 106 but instead prevents the spray mechanism 106 from being switched between the operating mode 108 and the safe mode 114. In addition to the key holder 136, a lock 140 is provided in the door 126, which may be unlocked with the same key 138 positioned in the holder 136. However, the lock 140 of the door need not be unlocked with the same key 138 used in the key holder 136 and the lock may be configured such that it is unlocked with a key other than the key 138 used in the key holder 136, for example.

The thermal spray apparatus 100 further includes a safety interlock for the spray mechanism 106, where the safety interlock switches between an operating condition where the spray mechanism 106 can operate in either of the operating mode 108 (FIG. 1) or the safe mode 114 (FIG. 2); and a safe condition in which the spray mechanism 106 is prevented from operating in the operating mode 108 (FIG. 1). More specifically, when the safety interlock is switched to the safe condition, the spray mechanism 106 is required to operate in the safe mode 114 (FIG. 2). In one exemplary embodiment, the safe mode 114 of the spray mechanism 106 involves a deactivation of the spray mechanism 106, such as a deactivation of the spray gun 117 to stop the emission 120 from the spray gun 117, for example. In another exemplary embodiment, the safe mode 114 of the spray mechanism 106 involves maintaining the position of the spray mechanism 106 in the parked position 116 (FIG. 2) behind the shield 104, for example.

The safety interlock is configured to switch to the safe condition once an operator 118 is enabled to enter the booth 102, such as to replace a sprayed component 112 with a next component to be sprayed, for example: In an exemplary embodiment, the safety interlock is switched to the safe condition if the door 126 is open. A sensor (not shown) may be positioned at the door 126, to transmit a signal to the controller 134 when the door 126 is open, for example, which is indicative of the operator 118 having entered the booth 102. In another exemplary embodiment, the safety interlock is switched to the safe condition if the switch 122 is activated while the door 126 is open, which is indicative that the spray mechanism 106 was moved from the parked position 116 while the operator is in the booth 102. In another exemplary embodiment, the safety interlock is switched to the safe condition if the key 138 is removed from the holder 136 of the control panel 133, as this is indicative of the operator 118 having removed the key 138 from the holder 136 to enter the booth 102. In another exemplary embodiment, the safety interlock is switched to the safe condition if the key 138 is removed from the holder 136 of the control panel 133 and used to unlock the lock 140 on the door 126, since this is also indicative of the operator 118 having removed the key 138 from the holder 136 to enter the booth 102. In another exemplary embodiment, the safety interlock is switched to the safe condition if the key 138 is removed from the holder 136 of the control panel 133, used to unlock the lock 140 on the door 126 and left in the lock 140 while the operator 118 enters the booth 102, since this is also indicative of the operator 118 having removed the key 138 from the holder 136 to enter the booth 102. FIG. 3 illustrates a diagram of the connection between the various components of the apparatus 100 in which the various versions of the safety interlock discussed above are available. In one embodiment of the safety interlock discussed above, the door 126 and the switch 122 transmit signals to the controller 134, when the spray mechanism 106 moves out of the parked position 116 while the door 126 is open, so that the controller 134 can switch the safety interlock into the safe mode, for example. In another embodiment of the safety interlock discussed above, the key holder 136 transmits a signal to the controller 134 when the key 138 is removed from the key holder 136, so that the controller 134 can switch the safety interlock into the safe mode, for example.

The safety interlock may be a software component of the controller 134 of the spray mechanism 106. In an exemplary embodiment, during the safe condition of the safety interlock, the controller 134 may be configured such that an operator cannot switch the spray mechanism 106 into the operating mode 108 (FIG. 1). For example, the controller 134 may be programmed such that the absence of the safe condition of the safety interlock is a precondition of switching the spray mechanism 106 into the operating mode 108 (FIG. 1). Alternatively, the safety interlock may be a hardware component of the thermal spray apparatus 100 which prevents the spray mechanism 106 from switching into the operating mode 108 (FIG. 1) when the safety interlock is in the safe condition. For example, the safety interlock may be a component (not shown) on the robot arm 115 of the spray mechanism 106 which prevents the spray mechanism 106 from moving out of the parked position 116 behind the shield 104 when the safety interlock is in the safe condition. In another example, the safety interlock may be a component on the spray gun 117 of the spray mechanism 106 which deactivates the spray gun 117 upon the spray mechanism 106 moving out of the parked position 116 behind the shield 104, when the safety interlock is in the safe condition. In another example, an “operating mode” selection button for the spray mechanism 106 on the controller 134 keypad (not shown) may be locked out during the safe condition of the safety interlock, so that the operator 118 cannot use the controller 134 keypad to switch the spray mechanism 106 into the operating mode 108 (FIG. 1) when the safety interlock is in the safe condition.

As illustrated in FIG. 4, the shield 104 may feature a tapered width from an inlet width 111 on an inlet side to an outlet width 109 on an outlet side opposite to the inlet side. The shield 104 also features a wall 105 with a thickness 107 and an inner surface 119 within an interior 152 of the shield 104 covered by an insulation material or a sound deadening material, such as an insulation fiberglass, for example. The inner surface 119 of sound deadening material is further covered by a perforated steel plate 123, to protect the sound deadening material. During the safe mode 114 (FIG. 2) when the spray mechanism 106 is positioned in the parked position 116 behind the shield 104, the emission 120 from the spray gun 117 in the idle mode includes fumes and dust, which are directed through the interior 152 of the shield 104 and out through the outlet 148 to the exhaust 146. As further illustrated in FIG. 4, a deflector plate 150 is secured within the interior 152 of the shield 104 to the inner surface of the shield 104. The deflector plate 150 is positioned to partially cover the outlet 148 of the shield 104, to create a tortuous path 151 of the fumes and dust from the spray mechanism 106 through the shield interior 152 and out through the outlet 148. By creating the tortuous path 151 of the fumes and dust through the shield 104, a flow rate of the fumes and dust through the outlet 148 and into the exhaust 146 is reduced, to reduce a likelihood of damage to the duct 146 by the fumes and dust. In an exemplary embodiment, the wall 105 is made from a square tube steel frame with a thickness 107 of 1″ and features outer skin sheet metal, for example. In another exemplary embodiment, the inlet width 111 is approximately 17.9″ and the outlet width 109 is approximately 8.1″, for example. In another exemplary embodiment, the perforated steel plate 123 has a thickness between 0.06-0.1″, for example. Although the above exemplary embodiments discuss numeric dimensions for the shield, these numeric dimensions are merely exemplary and the shield may take any particular dimensions which are sufficient to protect the operator in the booth from the spray mechanism. Additionally, although the above embodiments discuss the deflection plate 150 within the shield 104, the shield need not include the deflection plate, provided that the dust and fumes can be exhausted from the shield without damaging the outlet and/or the exhaust. Additionally, although the shield is described as having a tapered width from the inlet side to the outlet side, the shield is not limited to this shape or design, and may take a rectangular form or any non-tapered form, for example, which protects the operator in the booth from the emissions from the spray mechanism and achieves adequate suction to exhaust the dust and fumes within the shield interior.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A thermal spray apparatus, comprising:
a booth;
a shield within the booth;
a spray mechanism in the booth configured to switch between an operating mode at a spray position to spray a component mounted in the booth and a safe mode at a parked position behind the shield to protect an operator within the booth from an emission from the spray mechanism;
a switch associated with the spray mechanism configured to be activated upon a movement of the spray mechanism from the parked position;
a door to the booth; and
a safety interlock for the spray mechanism, said safety interlock configured to switch between an operating condition in which the spray mechanism is enabled to operate in either of the operating mode or the safe mode, and a safe condition in which the spray mechanism is prevented from operating in the operating mode, said safety interlock configured to switch to the safe condition upon the activation of the switch and the door being opened.

2. A thermal spray apparatus, comprising:
a booth;
a spray mechanism in the booth configured to switch between an operating mode and a safe mode, wherein an operator in the booth is protected from an emission from the spray mechanism in the safe mode; and
a safety interlock for the spray mechanism, said safety interlock configured to switch between an operating condition in which the spray mechanism is enabled to operate in either of the operating mode or the safe mode, and a safe condition in which the spray mechanism is prevented from operating in the operating mode, said safety interlock configured to switch to the safe condition upon an operator being enabled to enter the booth.

3. The thermal spray apparatus of claim 2, further comprising a shield within the booth; wherein said spray mechanism is positioned behind the shield in the safe mode.

4. The thermal spray apparatus of claim 2, further comprising a door to the booth; wherein said safety interlock is switched to the safe condition upon the door being open.

5. The thermal spray apparatus of claim 4, further comprising:
a shield within the booth wherein the spray mechanism is positioned behind the shield in the safe mode; and
a switch configured to be activated when the spray mechanism is moved from behind the shield;
wherein said safety interlock is switched to the safe condition upon an activation of the switch and the door being open.

6. The thermal spray apparatus of claim 2, further comprising a controller for the spray mechanism, said controller positioned external to the booth and including a holder for a key; wherein said safety interlock is switched to the safe condition upon a removal of the key from the holder.

7. The thermal spray apparatus of claim 6, further comprising:
a door to the booth including a lock configured to be unlocked by the key;
wherein said safety interlock is switched to the safe condition upon the removal of the key from the holder and the lock being unlocked with the key.

8. The thermal spray apparatus of claim 7, wherein said safety interlock is switched to the safe condition upon the removal of the key from the holder, the lock being unlocked with the key, said key remaining in the lock and the door being open.

9. The thermal spray apparatus of claim 5, wherein said switch is positioned at a base of the spray mechanism such that the switch is configured to detect a rotation of the spray mechanism base causing movement of the spray mechanism from behind the shield.

10. The thermal spray apparatus of claim 2, further comprising:
a shield within the booth wherein the spray mechanism is positioned behind the shield in the safe mode;
wherein the spray mechanism is oriented into an inlet of the shield during the safe mode and is configured to operate in an idle mode during the safe mode; and wherein the system further comprises an exhaust at an outlet of the shield to direct fumes and dust out of the shield during the idle mode.

11. The thermal spray apparatus of claim 10, further comprising a deflector plate positioned to partially cover the outlet of the shield, said deflector configured to deflect the fumes and dust moving from the spray mechanism to the outlet.

12. The thermal spray apparatus of claim 2, further comprising:
a shield within the booth wherein the spray mechanism is positioned behind the shield in the safe mode;
wherein an inner surface of the shield comprises a sound deadening material with a perforated steel cover plate.
